(19) United States
(12) Patent Application Publication
(10) Pub. No.: US 2013/0318553 A1
(43) Pub. Date: Nov. 28, 2013

(54) SYSTEM AND METHODS FOR ENHANCING OPERATION OF A GRAPHICAL USER INTERFACE

(71) Applicants: Oleksandr Yegorov, Kharkiv (UA); Alexander Paschenko, Kharkiv (UA)

(72) Inventors: Oleksandr Yegorov, Kharkiv (UA); Alexander Paschenko, Kharkiv (UA)

(73) Assignee: ECHOSTAR UKRAINE, L.L.C., Kharkiv (UA)

(21) Appl. No.: 13/579,236

(22) PCT Filed: Feb. 26, 2010
(86) PCT No.: PCT/UA2010/000008

§ 371 Date: Aug. 2, 2013

(51) Int. Cl. G06F 3/0482

(52) U.S. Cl. CPC G06F 3/0482
USPC 725/38; 715/727; 715/800

(57) ABSTRACT

A video services receiver system for providing video content to a display for viewing by a customer is presented here. The video services receiver system includes a receiver interface configured to receive data associated with video services, and a display interface for the display. The display interface provides a graphical interactive programming interface for the video services, the programming interface having a plurality of user-selectable elements. The video services receiver system also includes an audio interface configured to generate audio signals associated with operation of the video services receiver system. A processor of the system detects selection of one of the user-selectable elements, which results in a selected element. In response to selection of an element, the processor initiates generation of audio with the audio interface, the audio conveying content associated with the selected element. The processor may also initiate zooming in on the focused element in the graphical interactive programming interface.

### TECHNICAL FIELD

Embodiments of the subject matter described herein relate generally to graphical user interfaces, such as an interactive programming interface for a video services system. More particularly, embodiments of the subject matter relate to the use of selective display magnification and/or audio enhancements with a graphical user interface.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver system or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

Many conventional STBs are designed to generate and present program search menus and/or electronic programming guides for graphical rendering on a display device, such as a television or a monitor. The user can navigate onscreen guides or menus to identify or select a program, to set system preferences, to control recording and/or playback of video content, etc.

### BRIEF SUMMARY

An exemplary embodiment of a method of presenting information associated with graphical user interfaces is provided. The method provides a graphical user interface having a plurality of user-selectable elements. The method detects focus of one of the user-selectable elements and, in response to detecting focus, initiates an audible representation of content associated with the focused element.

Also provided is an exemplary embodiment of a video services receiver system for providing video content to a display for viewing by a customer. The video services receiver system includes a receiver interface configured to receive data associated with video services, and a display interface for the display. The display interface provides a graphical interactive programming interface for the video services, and the programming interface has a plurality of user-selectable elements. The video services receiver system also includes an audio interface configured to generate audio signals associated with operation of the video services receiver system. A processor is coupled to the receiver interface, the display interface, and the audio interface, and the processor is configured to detect selection of one of the user-selectable elements, and to initiate generation of audio with the audio interface, where the audio conveys content associated with the selected element.

Another exemplary method of presenting information associated with graphical user interfaces is also provided. This method begins by providing a graphical user interface having a plurality of user-selectable elements. The method continues by detecting focus of one of the user-selectable elements, and, in response to detecting focus, graphically magnifying the focused element in the graphical user interface.

Another exemplary embodiment of a video services receiver system is also provided. This video services receiver system includes: a receiver interface configured to receive data associated with video services; a display interface for the display, the display interface providing a graphical interactive programming interface for the video services, the programming interface having a plurality of user-selectable elements; and a processor coupled to the receiver interface and to the display interface, the processor being configured to detect selection of one of the user-selectable elements, which results in a selected element, and the processor being configured to initiate zooming in on the focused element in the graphical interactive programming interface.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a video services broadcasting system;

FIG. 2 is a schematic representation of an embodiment of a set-top box suitable for use in the video services broadcasting system shown in FIG. 1;

FIG. 3 is a flow chart that illustrates an exemplary embodiment of an enhanced GUI navigation process; and

FIGS. 4-7 are exemplary screen shots of interactive GUIs.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following

### DETAILED DESCRIPTION

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. Moreover, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

Although the techniques and technology presented here can be employed in the context of any appropriately designed GUI, menu, or control instrument, the exemplary embodiment described below relates to a video delivery system such as a satellite television system. The disclosed subject matter relates to the generation and rendering of an interactive GUI, namely, an interactive programming guide or interface that can be traversed and manipulated by a user to control the operation of the video delivery system. More specifically, the disclosed subject matter relates to certain enhancements in the interactive programming guide; these enhancements are particularly beneficial for users with poor eyesight and/or in situations where the distance between the user and the system display is relatively far.

In particular, systems and methodologies for providing audio support for navigating a graphical menu and/or a program guide are described herein. Audio support enables the user to browse and navigate the GUI in an effective manner and such that the user need not actually have a clear view of the displayed GUI itself. Text, labels, menu items, and other displayed GUI elements can be annunciated using stored audio files and/or using a suitably configured text-to-speech synthesizer. In some implementations, display magnification may be used in addition to (or in lieu of) the audio support feature. In this regard, when a displayed GUI element is selected, that element is magnified by a certain amount to facilitate easier reading by the user. Accordingly, the techniques and methodologies described here can be used to facilitate menu and program guide navigation for users with poor eyesight, for users who do not have a clear view of the display, and/or for users with poor reading ability.

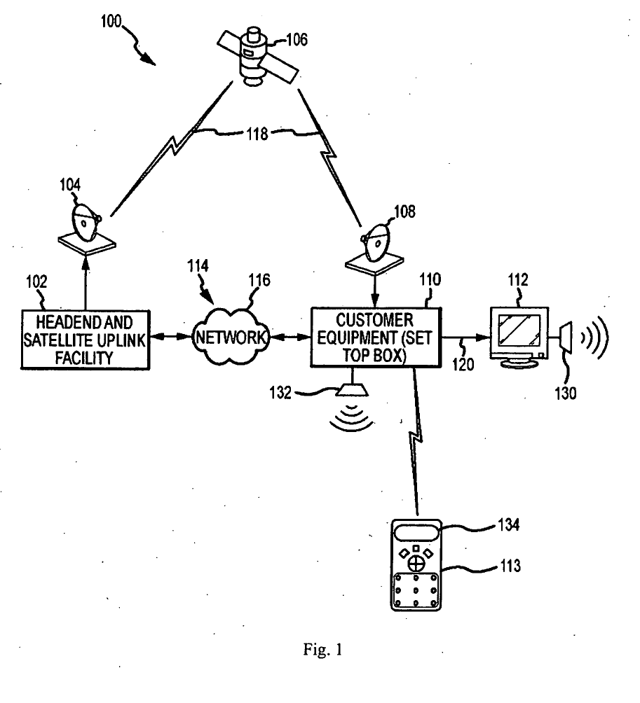

FIG. 1 is a schematic representation of an embodiment of a video services broadcasting system 100 that is suitably configured to support the enhanced GUI navigation techniques described below. The system 100 (which has been simplified for purposes of illustration) generally includes, without limitation: a data center 102; an uplink transmit antenna 104; a satellite 106; a downlink receive antenna 108; a video services receiver 110 or other customer equipment; and a display device 112. In typical deployments, the video services receiver 110 can be remotely controlled using a wireless remote device 113. In certain embodiments, the data center 102 communicates with the video services receiver 110 via a back-channel connection 114, which may be established through one or more data communication networks 116. For the sake of brevity, conventional techniques related to satellite communication systems, satellite broadcasting systems, DVB systems, data transmission, signaling, network control, and other functional aspects of the systems (and the individual operating components of the systems) may not be described in detail herein.

The data center 102 may be deployed as a headend facility and/or a satellite uplink facility for the system 100. The data center 102 generally functions to control content and data sent over a high-bandwidth link 118 to any number of downlink receive components (only one downlink receive antenna 108, corresponding to one customer, is shown in FIG. 1). In practice, the data center 102 also provides content and data that is used to populate an interactive programming guide generated by the video services receiver 110. In the embodiment shown in FIG. 1, the high-bandwidth link 118 is a direct broadcast satellite (DBS) link that is relayed by the satellite 106, although equivalent embodiments could implement the high-bandwidth link 118 as any sort of cable, terrestrial wireless and/or other communication link as desired.

The data center 102 includes one or more conventional data processing systems or architectures that are capable of producing signals that are transmitted via the high-bandwidth link 118. In various embodiments, the data center 102 represents a satellite or other content distribution center having: a data control system for controlling content, signaling information, blackout information, programming information, and other data; and an uplink control system for transmitting content, signaling information, blackout information, programming information, and other data using the high-bandwidth link 118. These systems may be geographically, physically and/or logically arranged in any manner, with data control and uplink control being combined or separated as desired.

The uplink control system used by system 100 is any sort of data processing and/or control system that is able to direct the transmission of data on the high-bandwidth link 118 in any manner. In the exemplary embodiment illustrated in FIG. 1, the uplink transmit antenna 104 is able to transmit data to the satellite 106, which in turn uses an appropriate transponder for repeated transmission to the downlink receive antenna 108.

Under normal operating conditions, the satellite 106 transmits content, signaling data, blackout information, programming data, and other data to the downlink receive antenna 108, using the high-bandwidth link 118. In practical embodiments, the downlink receive antenna 108 represents the customer's satellite dish, which is coupled to the video services receiver 110. The video services receiver 110 can be realized as any device, system or logic capable of receiving signals via the high-bandwidth link 118 and the downlink receive antenna 108, and capable of providing demodulated content to a customer via the display device 112.

The display device 112 may be, without limitation: a television set; a monitor; a computer display; or any suitable customer appliance with compatible display capabilities. In various embodiments, the video services receiver 110 is a conventional set-top box commonly used with DBS or cable television distribution systems. In other embodiments, however, the functionality of the video services receiver 110 may be commonly housed within the display device 112 itself In still other embodiments, the video services receiver 110 is a portable device that may be transportable with or without the display device 112. The video services receiver 110 may also be suitably configured to support broadcast television reception, video game playing, personal video recording and/or other features as desired.

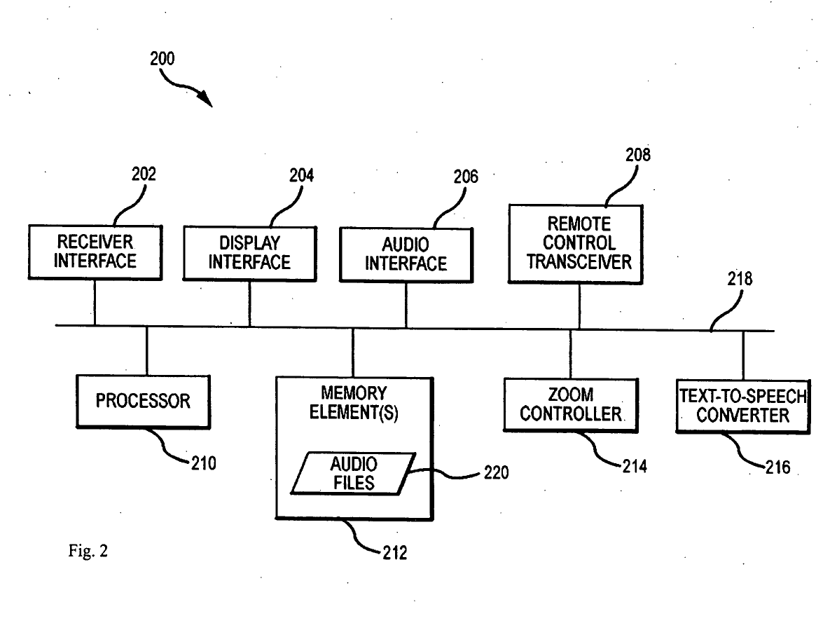

During typical operation, the video services receiver 110 receives programming (broadcast events), signaling information, and/or other data via the high-bandwidth link 118. The video services receiver 110 then demodulates, decompresses, descrambles, and/or otherwise processes the received digital data, and then converts the received data to suitably formatted video signals 120 that can be rendered for viewing by the customer on the display device 112. Additional features and functions of the video services receiver 110 are described below with reference to FIG. 2.

The system 100 includes one or more speakers, transducers, or other sound generating elements or devices that are utilized for playback of sounds during operation of the system 100. These sounds may be, without limitation: the audio portion of a video channel or program; the content associated with an audio-only channel or program; audio related to the navigation of the graphical programming guide; confirmation tones generated during operation of the system; alerts or alarm tones; or the like. Depending upon the embodiment, the system 100 may include a speaker 130 (or a plurality of speakers) attached to, incorporated into, or otherwise associated with the display device. Alternatively or additionally, the system 100 may include a speaker 132 (or a plurality of speakers) attached to, incorporated into, or otherwise associated with the video services receiver 110. Alternatively or additionally, the system 100 may include a speaker 134 (or a plurality of speakers) attached to, incorporated into, or otherwise associated with the remote device 113. Notably, one or more of the speakers 130 and 132 might be deployed as part of a home theater, stereo, or other entertainment system provided separately from the system 100.

FIG. 2 is a schematic representation of an embodiment of a set-top box 200. The set-top box 200 is one exemplary embodiment of a video services receiver system suitable for use in the video services broadcasting system 100 shown in FIG. 1. The set-top box 200 is configured to receive video content, and to provide the video content to an appropriate display for viewing by a customer or user. The set-top box 200 also supports features that enhance the user experience while navigating on-screen menus, GUIs, interactive programming guides, and the like. These enhanced GUI navigation features are described in more detail below. This illustrated embodiment of the set-top box 200 generally includes, without limitation: a receiver interface 202; a display interface 204 for the display; an audio interface 206; a remote control transceiver 208; at least one processor 210; at least one memory element 212; a zoom controller 214; and a text-to-speech converter 216. These components and elements may be coupled together as needed for purposes of interaction and communication using, for example, an appropriate interconnect arrangement or architecture 218. It should be appreciated that the set-top box 200 represents a “full featured” embodiment that supports various GUI zooming/magnification and audio enhanced GUI features. In practice, an implementation of the set-top box 200 need not support all of the enhanced features described here and, therefore, one or more of the elements depicted in FIG. 2 may be omitted from a practical embodiment. Moreover, a practical implementation of the set-top box 200 will include additional elements and features that support conventional functions and operations.

The receiver interface 202 is coupled to the customer's satellite antenna, and the receiver interface 202 is suitably configured to receive and perform front end processing on signals transmitted by satellite transponders. In this regard, the receiver interface 202 can receive data associated with any number of services, including data that is used to populate on-screen menus, GUIs, interactive programming interfaces, etc. The receiver interface 202 may leverage conventional design concepts that need not be described in detail here.

The display interface 204 is coupled to one or more display elements (not shown) at the customer site. The display interface 204 represents the hardware, software, firmware, and processing logic that is utilized to render graphics, images, video, and other visual indicia on the customer's display. For example, the display interface 204 is capable of providing graphical interactive programming interfaces for video services, interactive graphical menus, and other GUIs for display to the user. The display interface 204 may leverage conventional design concepts that need not be described in detail here.

The audio interface 206 is coupled to one or more audio system components (not shown) at the customer site. The audio interface 206 represents the hardware, software, firmware, and processing logic that is utilized to generate and provide audio signals associated with the operation of the set-top box 200. Depending upon the particular embodiment, the audio interface 206 may be tangibly or wirelessly connected to the audio portion of a television or monitor device, or it may be tangibly or wirelessly connected to a sound system component that cooperates with the television or monitor device.

The remote control transceiver 208 performs wireless communication with one or more compatible remote devices, such as a remote control device, a portable computer, an appropriately equipped mobile telephone, or the like. The remote control transceiver 208 enables the user to remotely control various functions of the set-top box 200, in accordance with well known techniques and technologies. In certain embodiments, the remote control transceiver 208 is also used to transmit audio files to a remote device (such that the remote device can execute playback of the audio files upon receipt). As explained in more detail below, transmitted audio files may be used to support audio-enhanced GUI navigation features.

The processor 210 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor 210 may be realized as a microprocessor, a controller, a microcontroller, or a state machine. Moreover, the processor 210 may be implemented as a combination of computing devices, e.g., a combination of a digital signal processor and a microprocessor, a plurality of microprocessors, one or more microprocessors in conjunction with a digital signal processor core, or any other such configuration.

The memory element 212 may be realized as RAM memory, flash memory, EPROM memory, EEPROM memory, registers, a hard disk, a removable disk, or any other form of storage medium known in the art. In certain embodiments, the memory element 212 includes or is realized as a hard disk, which may also be used to support integrated DVR functions of the set-top box 200. The memory element 212 can be coupled to the processor 210 such that the processor 210 can read information from, and write information to, the memory element 212. In the alternative, the memory element 212 may be integral to the processor 210. As an example, the processor 210 and the memory element 212 may reside in a suitably designed ASIC. As depicted in FIG. 2, the memory element 212 may be used to store and maintain audio files 220 that correspond to selectable graphical elements that can be displayed with a GUI, an interactive menu, a programming guide, or the like. The audio files 220 may be stored in any suitable lossless or lossy format, including, without limitation: WAV; AIFF; FLAC; WMA; MP3; MP2; AAC; Vorbis; WavPack; and Monkey's Audio. Moreover, the set-top box 200, the audio interface 206, and compatible remote peripheral devices could support different audio file formats, and the memory element 212 could accommodate the storage of any number of different audio file types. The audio files 220 may originate at any suitable source. For example, the audio files 220 may be provided to the set-top box 200 by the headend facility, via the Internet, over the air, by preloading at the factory, etc. Depending upon the specific embodiment, the audio files 220 may support any number of different languages.

The zoom controller 214 may be realized as a module of the processor 210 and/or with appropriate processing logic, hardware, software, firmware, or the like. The zoom controller 214 controls, manages, and executes zooming (in and out) or magnification associated with graphical elements of GUIs, menus, interactive programming guides, and/or other display items provided by the set-top box 200. In this regard, the zoom controller 214 can detect or determine when certain user-selectable elements of a GUI are in focus or have otherwise been selected, detect or determine when certain user-selectable elements of a GUI are out of focus or have otherwise been deselected, and respond in an appropriate manner. For example, if the user focuses on a particular interactive graphical element, the zoom controller 214 can graphically magnify (zoom in on) the focused element to make the focused element easier to read. When a graphical element loses focus, however, the zoom controller 214 can remove the magnification effect and render that element using its default size and display characteristics.

The text-to-speech converter 216 may be realized as a module of the processor 210 and/or with appropriate processing logic, hardware, software, firmware, or the like. The text-to-speech converter 216 is suitably configured to convert text into synthesized speech, so that the synthesized speech can be audibly annunciated to the user. If the text is displayed with a GUI element, the text-to-speech converter 216 can translate the displayed text into synthesized speech. Depending upon the specific embodiment, the text-to-speech converter 216 may support any number of different languages. It should be appreciated that the text-to-speech converter 216 need not be employed if the set-top box 200 uses the audio files 220, and vice versa.

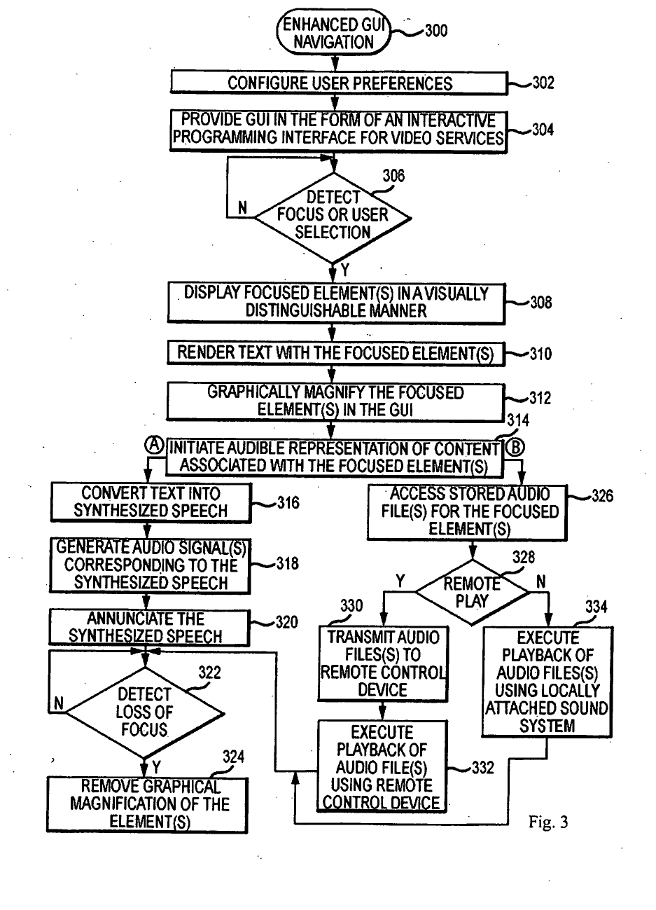

The system 100 (FIG. 1) and the set-top box 200 (FIG. 2) can be used to provide audio-enhanced and/or zoom-enhanced operation of a GUI, onscreen menu, interactive programming guide, or other displayed items. In this regard, FIG. 3 is a flow chart that illustrates an exemplary embodiment of an enhanced GUI navigation process 300. The various tasks performed in connection with the process 300 may be performed by software, hardware, firmware, or any combination thereof. For illustrative purposes, the following description of the process 300 may refer to elements mentioned above in connection with FIGS. 1 and 2. In practice, portions of the process 300 may be performed by different elements of the described system, e.g., a set-top box, a remote device, an audio system component, or the like. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

For the sake of completeness, FIG. 3 illustrates an embodiment of the process 300 that supports both types of enhancements: audio and zooming In practice, however, an embodiment may support only one type of enhancement, or the user may be able to selectively activate only one of the two enhancement types. In this regard, the process 300 may begin by configuring certain user preferences or options (task 302) that relate to the enhanced GUI navigation features. For instance, task 302 may allow the user to activate or disable the audio enhancement feature, the zooming feature, or both. In addition, task 302 may allow the user to set options or otherwise influence the manner in which the process 300 handles the execution of the enhanced features. For example, task 302 might enable the user to choose a magnification or zooming level, e.g., 2×, 3×, 4×, or 5× magnification. As another example, task 302 might allow the user to select audio playback from stored audio files versus synthesized speech. As yet another example, task 302 could give the user the option to use local audio playback (e.g., with the same audio system that is used to generate sound for the video services) and/or remote audio playback (e.g., with a compatible remote control device). Task 302 could also give the user the option to select how much information is audibly annunciated. For instance, an entry in a programming guide may include information such as: the channel identifier; the time slot; the program name or title; and a description of the program. In this regard, task 302 could allow the user to select which of these “fields” are audibly announced while traversing a programming guide.

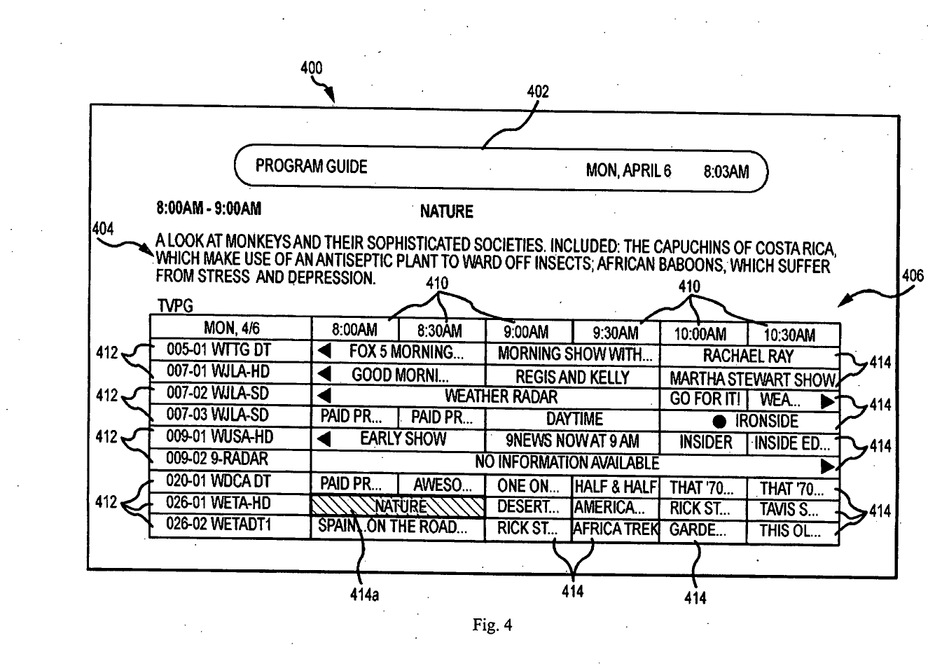

During operation of the set-top box, the process 300 can be used to generate and provide an appropriate GUI for display. This example assumes that the process 300 provides a GUI in the form of a graphical interactive programming interface for video services (task 304). In this regard, FIG. 4 is an exemplary screen shot of an interactive programming interface 400. This programming interface 400 is realized as a GUI having a plurality of user-selectable elements. The programming interface 400 represents a program listing for a video services system, and it generally includes, without limitation: a date/time field 402; a program description area 404; and a program list window 406. For this embodiment, the date/time field 402 includes text that identifies the current day (e.g., Monday), the current date (e.g., April 6), and the current time (e.g., 8:03 AM). The date/time field 402 may be a user-selectable or focusable element of the programming interface 400. The program description area 404 may be used to provide additional information or data for a selected program. For example, the program description area 404 could be used to indicate (in text), without limitation: the designated time slot of the selected program; the title or name of the selected program; the rating (or other classification or category) of the selected program; a brief summary or abstract related to the content of the selected program; etc. In certain embodiments, the program description area 404 is a user-selectable or focusable element of the programming interface 400.

The program list window 406 may be used to indicate programming associated with different available video services. In typical implementations, the program list window 406 will include alphanumeric characters that identify certain time slots (which may be scrollable such that the user can view programming for different days/times), along with the different programs offered during those time slots. Accordingly, the program list window 406 may include text associated with time slot identifiers 410, channel identifiers 412, and program identifiers 414. Each of these identifiers might be generated and rendered as a user-selectable or focusable element of the programming interface 400. In this regard, FIG. 4 depicts the state of the programming interface 400 at a time when the program identifier 414a (for the program titled “Nature”) has been selected. Notably, the program description area 404 identifies the title of the program, its time slot, and a brief description of its content.

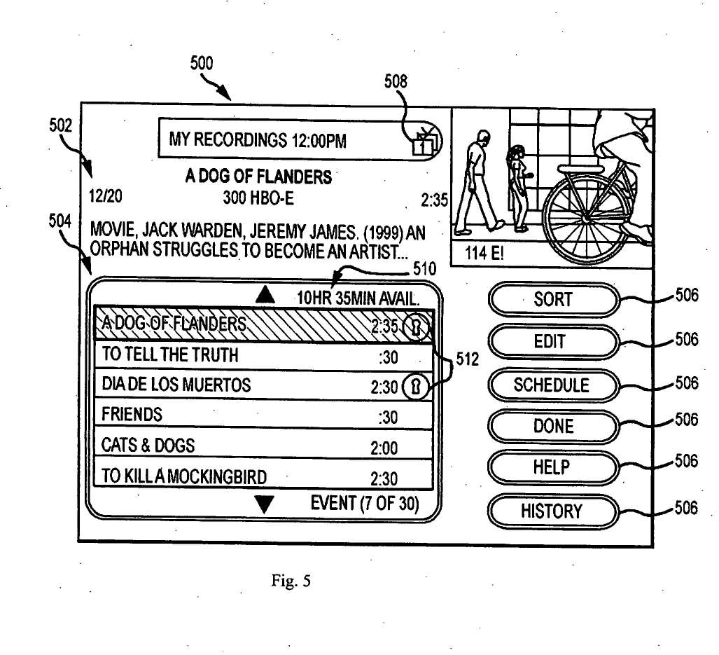

The GUI enhancements described here need not be limited to an interactive programming guide. In this regard, FIG. 5 is an exemplary screen shot of an interactive menu 500 that might be provided by a set-top box. This interactive menu 500 is merely one possible menu (with user-selectable elements) that could be generated by a set-top box. The interactive menu 500 relates to recorded content, and it includes, without limitation: a program description area 502; a recorded program list window 504; and various command buttons 506. This version of the interactive menu 500 also includes a receiver, tuner, or television identifier 508 (e.g., TV1 or TV2 for a component having dual receivers or tuners). The program description area 502 may be used to provide additional information or data for a selected program. In this regard, the program description area 502 is similar to the program description area 404 described above with reference to FIG. 4. In certain embodiments, the program description area 502 is a user-selectable or focusable element of the interactive menu 500.

The recorded program list window 504 may be used to indicate content that has been recorded. In typical implementations, the recorded program list window 504 will include text to identify the recorded programs (by title, channel number, and/or other identifiers) and their respective recorded/playback times or event durations. A recorded program that has been locked will have a lock status icon 512 displayed with its listing, as shown in FIG. 5. The lock status icon 512 is removed when the program is unlocked. The illustrated version of the recorded program list window 504 also includes an indication of the time available for recording 510. Each entry in the recorded program list window 504 might be generated and rendered as a user-selectable or focusable element of the interactive menu 500. In this regard, FIG. 5 depicts the state of the interactive menu 500 at a time when the program titled “A Dog of Flanders” has been selected. Notably, the program description area 502 identifies the title of the program, its date, its recorded/playback length, and a brief description of its content.

Each of the command buttons 506 is generated and rendered as a user-selectable or focusable element of the interactive menu 500. This example includes six command buttons 506 that can be activated to perform different functions: Sort; Edit; Schedule; Done; Help; and History. Moreover, each of the command buttons 506 is rendered with a text label that indicates its function or feature. In practice, these functions are relevant to program recording, recorded content management, and the like.

It should be appreciated that a set-top box could be suitably designed to render GUIs, interactive menus, programming guides or interfaces, and/or other display screens having any number of user-selectable elements, which may or may not include corresponding text, labels, descriptors, or identifiers rendered therewith. The examples shown in FIGS. 4 and 5 are not intended to be exhaustive or limiting in any way. In this regard, a user-selectable element of an onscreen display may include or correspond to any of the following items, without limitation: a menu name; a menu descriptor; a programming channel number; a programming channel name; a network name; a service provider name; a current date; a current time; a program start time; a program end time; a program time slot; a program title; a program content description; a recording control element; a TV name or identifier (such as TV1 or TV2 for components with dual receivers/tuners); the time available for recording; the event duration; lock status; and a playback control element.

Referring again to FIG. 3, the process 300 monitors the state of the GUI as the user navigates it. Typically, the user will navigate the GUI by manipulating a remote control device, which controls the movement of an onscreen cursor or pointer. As the cursor moves in the GUI, different graphical elements gain and lose focus. As used here, an element is “in focus” or is a “focused element” when it has been selected or is capable of being selected. A focused element could result in the activation of a feature or an operation, or it could result in the display of additional information associated with the focused element. A focused element could also represent an element that is ready for activation via a user command or button-press. For example, in FIG. 4 the program identifier 414a for the program titled “Nature” has been selected and is currently in focus. As a result, the program description area 404 contains a brief summary of the program titled “Nature.” As another example, when one of the command buttons 506 (see FIG. 5) is in focus, the user can activate that focused element by pressing a button on the remote control device.

When the process 300 detects focus or user selection of one or more of the user-selectable elements of the GUI (query task 306), then it may proceed by displaying the focused element(s) in a visually distinguishable manner (task 308). The visually distinguishable characteristics can be specified such that the user can quickly and easily interpret the display to determine which graphical element is in focus. In this regard, the different visually distinguishable characteristics may correspond to any of the following characteristics, individually or in any combination thereof: different colors; different brightness; different transparency levels; different translucency levels; different line patterns; different line thickness; different shapes; different flicker patterns; different focus levels; different sharpness levels; or different clarity levels. For example, FIG. 4 depicts how the focused program identifier 414a for the program titled “Nature” has been rendered in a highlighted manner, relative to the remaining program identifiers 414 (which are not currently in focus).

This example assumes that the process 300 renders and displays text or some alphanumeric characters with the focused element (task 310), e.g., the word “Nature” appears with the display of the program identifier 414a. For this exemplary embodiment, the process 300 responds to the detection of focus by initiating zooming in on the focused element in the GUI. More specifically, the process 300 proceeds by graphically magnifying the focused element in the GUI (task 312). In certain implementations, task 312 occurs automatically without any additional user involvement or interaction. In other implementations, the magnification of the focused element only occurs after the set-top box receives some form of user confirmation. For example, magnification may be activated in response to focus of an element combined with user manipulation of a button on the remote control device. Thus, magnification of focused elements can be selectively controlled as needed by the user, or it may be automatically executed when elements gain focus.

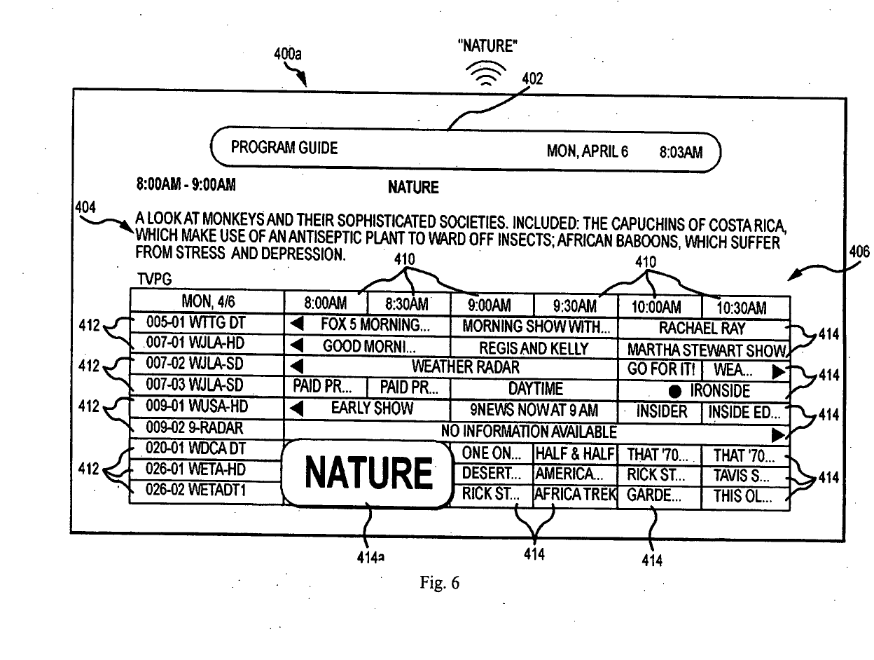

FIG. 6 depicts the state of the interactive programming interface 400a after the focused program identifier 414a has been magnified. For this example, the displayed size of the text label “Nature” has been increased significantly for improved visibility. Thus, zooming in on the focused element may also result in magnification of any text associated with that focused element. In addition, the overall boundary of the focused program identifier 414a has been expanded such that it “overlaps” some of its neighboring cells. In certain embodiments, the font used for the magnified text is altered for improved visibility. For example, the text may be rendered in all capital letters, using a boldface font, or the like. Different visually distinguishable characteristics (as mentioned above) could also be used to render the magnified text in a more distinct and noticeable manner.

The illustrated embodiment of the process 300 also supports audio enhanced GUI navigation. Accordingly, when focus of a graphical element is detected the process 300 initiates an audible representation of content that is associated with or otherwise linked to the focused element (task 314). This results in the generation or playback of sounds corresponding to the focused element. More specifically, the audible representation of content might include an audible annunciation of text that is rendered with the focused element. In this regard, audio signals or sound waves are generated in a manner that conveys the content associated with the selected graphical element.

As mentioned previously, a set-top box could be designed to support audio playback using different techniques and/or audio sources. For this reason, FIG. 3 includes two branches leading from task 314 (labeled A and B). Branch A relates to the use of a text-to-speech converter, and branch B relates to the use of stored audio files. Either or both of these approaches could be utilized to generate audio corresponding to the focused element(s). Referring to branch A, the process 300 converts or translates the text of the focused element into synthesized speech (task 316). Task 316 may be accomplished by accessing or otherwise obtaining data corresponding to the text that is displayed with the focused element. This text data can then be processed with a text-to speech converter to generate synthesized speech signals that convey the same content as the displayed text. In this regard, the process 300 generates audio signals that correspond to the synthesized speech (task 318) and the audio signals are used to audibly annunciate the synthesized speech (task 320) using an appropriate audio system. In practice, the audio signals can be provided to the audio components of a television or monitor device, and/or to a stereo or home theater system that cooperates with the set-top box.

If the process 300 detects loss of focus of the graphical element (query task 322), then the graphical magnification of the graphical element is removed or otherwise disabled (task 324). In other words, loss of focus initiates zooming out on the focused element. This returns the previously focused element back to its unfocused format. Thus, the process 300 may operate to selectively magnify user-selectable elements of a GUI as the user traverses the GUI. As elements gain focus, they are rendered in a magnified format while other elements are rendered in a nominal manner.

Referring back to task 314, branch B of the process 300 relates to the processing of stored audio files (rather than the generation of synthesized speech). As described above, audio files for different GUIs can be stored and maintained by the set-top box, and these audio files can be used to support the audio enhancement feature. Thus, the audible representation of content can be initiated by accessing one or more stored audio files (task 326) for the focused element. Depending upon the embodiment, stored audio files can be played locally and/or remotely. If the audio file will be remotely played (query task 328), then it will be transmitted to a remote device, such as the remote controller used for the set-top box (task 330). Transmission of audio files in this manner will typically be performed wirelessly, although a wired connection could be employed. Upon receipt, the remote device executes playback of the audio file (task 332) using its native processing capabilities. If the audio file will be locally played, then it can be executed for playback using the set-top box itself, using the attached monitor or television component, using an attached stereo or home theater system, or the like. Thereafter, the process 300 may proceed to task 322, as described above.

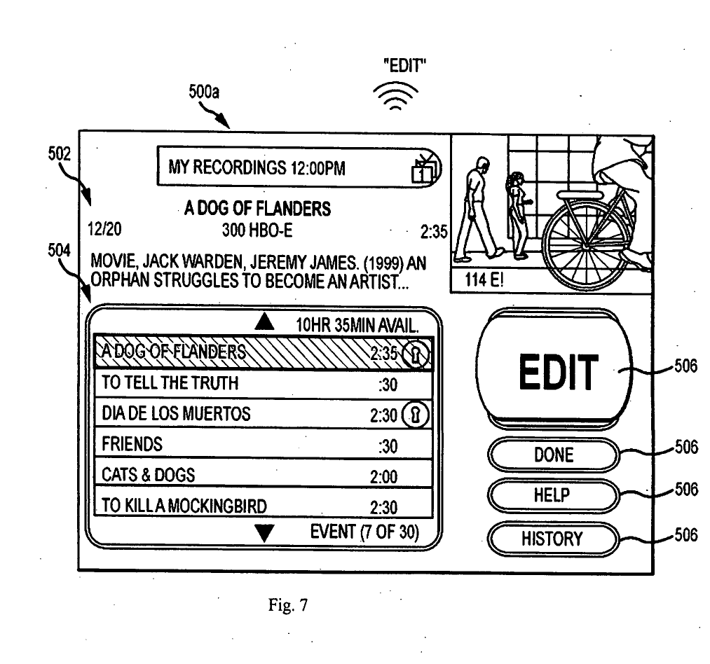

FIG. 6 depicts the state of the interactive programming interface 400a after the focused program identifier 414a has been magnified. FIG. 6 also schematically depicts how the word “Nature” can be audibly annunciated when the program identifier 414a gains focus. Consequently, the programming interface 400a is enhanced with audio announcement and visual magnification features. Similarly, FIG. 7 depicts the state of the interactive menu 500a after the focused command button 506a has been magnified. FIG. 7 schematically depicts how the word “Edit” can be announced when the command button 506a gains focus. In this manner, the interactive menu 500a can also be provided with audio enhancements and/or visual magnification enhancements.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of presenting information associated with graphical user interfaces, the method comprising:
providing a graphical user interface having a plurality of user-selectable elements;
detecting focus of one of the user-selectable elements, which corresponds to a focused element; and
in response to detecting focus, initiating an audible representation of content associated with the focused element.

2. The method of claim 1, further comprising rendering text with the focused element, wherein the audible representation of content comprises an audible annunciation of the text.

3. The method of claim 2, further comprising converting the text into synthesized speech using a text-to-speech converter, wherein the audible annunciation comprises the synthesized speech.

4. The method of claim 1, further comprising maintaining an audio file for the focused element, wherein initiating the audible representation of content comprises accessing the audio file.

5. The method of claim 4, further comprising executing playback of the audio file.

6. The method of claim 4, further comprising transmitting the audio file to a remote device, wherein the remote device executes playback of the audio file.

7. The method of claim 1, wherein:
the graphical user interface is a program listing for a video services system; and
the plurality of user-selectable elements includes elements selected from the group consisting of: a menu name; a menu descriptor; a programming channel number; a programming channel name; a network name; a service provider name; a current date; a current time; a program start time; a program end time; a program time slot; a program title; a program content description; a recording control element; a receiver or tuner name or identifier; a time available for recording; an event duration; a lock status; and a playback control element.

8. The method of claim 1, further comprising magnifying the focused element in the graphical user interface.

9. A video services receiver system for providing video content to a display for viewing by a customer, the video services receiver system comprising:
a receiver interface configured to receive data associated with video services;
a display interface for the display, the display interface providing a graphical interactive programming interface for the video services, the programming interface having a plurality of user-selectable elements;
an audio interface configured to generate audio signals associated with operation of the video services receiver system; and
a processor coupled to the receiver interface, the display interface, and the audio interface, the processor being configured to detect selection of one of the user-selectable elements, which results in a selected element, and the processor being configured to initiate generation of audio with the audio interface, the audio conveying content associated with the selected element.

10. The video services receiver system of claim 9, wherein the selected element includes text displayed therewith, and the audio includes an audible annunciation of the text.

11. The video services receiver system of claim 10, further comprising a text-to-speech converter coupled to the processor, wherein the text-to-speech converter translates the text into synthesized speech, and wherein the audible annunciation comprises the synthesized speech.

12. The video services receiver system of claim 9, further comprising a memory element that stores audio files corresponding to the user-selectable elements.

13. The video services receiver system of claim 12, wherein the processor initiates the generation of audio by accessing the audio files.

14. The video services receiver system of claim 9, further comprising a remote control transceiver coupled to the processor, wherein the remote control transceiver transmits the audio files to a remote device, and wherein the remote device executes playback of the audio file.

15. A method of presenting information associated with graphical user interfaces, the method comprising:
providing a graphical user interface having a plurality of user-selectable elements;
detecting focus of one of the user-selectable elements, which corresponds to a focused element; and
in response to detecting focus, graphically magnifying the focused element in the graphical user interface.

16. The method of claim 15, wherein graphically magnifying the focused element occurs automatically in response to detecting focus, and without any user involvement.

17. The method of claim 15, further comprising receiving a user confirmation in response to detecting focus, wherein graphically magnifying the focused element occurs in response to receiving the user confirmation.

18. The method of claim 15, further comprising:
detecting loss of focus of the focused element; and
in response to detecting loss of focus, removing graphical magnification of the focused element.

19. The method of claim 15, further comprising initiating an audible representation of content associated with the focused element.

20. A video services receiver system for providing video content to a display for viewing by a customer, the video services receiver system comprising:
a receiver interface configured to receive data associated with video services;
a display interface for the display, the display interface providing a graphical interactive programming interface for the video services, the programming interface having a plurality of user-selectable elements; and
a processor coupled to the receiver interface and to the display interface, the processor being configured to detect selection of one of the user-selectable elements, which results in a selected element, and the processor being configured to initiate zooming in on the focused element in the graphical interactive programming interface.

21. The video services receiver system of claim 20, the processor being configured to:
detect loss of focus of the focused element; and
in response to the loss of focus, initiate zooming out on the focused element.

22. The video services receiver system of claim 20, wherein:
the focused element includes text rendered therewith; and
zooming in on the focused element results in magnification of the text.
